(19) United States
(12) Patent Application Publication
(10) Pub. No.: US 2011/0004183 A1
(43) Pub. Date: Jan. 6, 2011

(54) Interface Device for Bottles Designed to be Perforated for the Preparation of Infused Liquids

(75) Inventors: Jean-Luc Carrez, Ecouen (FR); Jean-Louis Coussegal, Beauchamp (FR); Laurent Barre, Ecouen (FR); Pierrick Guyomarc'h, Ermont (FR)

Correspondence Address: LEVINE & MANDELBAUM, 222 Bloomingdale Road, Suite 203, WHITE PLAINS, NY, 10605, US

(73) Assignee: VYGON, Ecouen (FR)

(21) Appl. No.: 12/920,674

(22) PCT Filed: Mar. 11, 2009
(86) PCT No.: PCT/EP09/52882

§ 371 Date: Sep. 16, 2010

(30) Foreign Application Priority Data
Mar. 12, 2008 (FR) 0851620

(51) Int. Cl. A61J 1/14

(52) U.S. Cl. 604/405

(57) ABSTRACT

An interface device for connecting a syringe to a perforable bottle containing a drug has a base for connection to the perforable bottle. The connection base has an air circulation device for allowing air in and out of the perforable bottle and filtering the air.

The invention concerns an interface device designed to connect a syringe to a perforable bottle containing a drug for liquid preparations designed to be infused in a patient.

In oncology, to treat cancerous tumors, it is necessary to infuse very aggressive liquids. The preparation of these liquids in solution form can be dangerous for the caregiver. In many cases, the drug that must be administered assumes the form of powder in a vacuum bottle (called Vial). This bottle is sealed by a stopper with an elastomer membrane.

In order to mix this drug contained in such a vacuum bottle with a liquid adapted to be infused, it is first necessary to dilute the powdered drug in this liquid using a syringe. For this, the syringe is equipped with a needle. This syringe contains liquid to be infused, such as physiological saline solution (distilled water+NaCl). The elastomer-membrane stopper of the bottle is then passed through with the needle, which results in causing air to abruptly enter the bottle that was in vacuum. This air that abruptly enters mixes with the powdered drug and can come back out in part while bringing pure drug with it, which is hazardous for the caregiver responsible for the preparation. Once the needle of the syringe is placed through the elastomer-membrane stopper, the caregiver responsible for the preparation pushes, using the syringe, liquid to be infused into the bottle, which again causes air to come out, possibly with particles of drugs that are not yet diluted. The bottle is then shaken and the mixture is suctioned through the elastomer-membrane stopper using the syringe. In practice, the liquid mixture to be infused plus diluted drug is injected and suctioned several times in a row outside and inside the bottle with the syringe, in order to mix the drug well with the liquid. Each time, air exits and enters the bottle, which involves pollution risks for the caregiver responsible for the preparation, on one hand, and on the other hand, for the prepared mixture.

Lastly, the needle is taken out of the bottle. It is then necessary to disconnect it from the syringe without pricking oneself and to avoid any direct contact of the mixture thus produced with the caregiver responsible for the preparation. The filled syringe is then connected close to the patient to a drip pouch connected to the syringe or connected directly to the patient.

One aim of the invention is to provide an interface device situated between the perforable bottle containing the pure drug in powdered form and the syringe containing the liquid to be infused, that is secured while remaining easy to use during the preparation of the mixture between the liquid to be infused and the pure drug situated in the perforable bottle.

To this end, provided according to the invention is an interface device designed to connect a syringe with a perforable bottle containing a drug, comprising a base for connection to the perforable bottle, the connection base including air circulation means, designed to allow air in and out of the perforable bottle, comprising air filtration means.

Thus, the use of air circulation means equipped with means for filtering said air imposes an air circulation between the bottle and the outside, passing through the filtration means that will then retain, on one hand when air leaves the bottle, the particles of pure drug that are not yet diluted, and, on the other hand, when air enters the bottle, impurities contained in the ambient air penetrating the bottle. This makes it possible to secure the handling and preparation of the mixture.

Advantageously, but optionally, the interface device includes at least one of the following features:

the device includes a hollow perforation needle,

the air circulation means comprises a tubule designed to extend in the perforable bottle at a distal end of the tubule,

the hollow perforation needle is slidingly mounted with functional play in the tubule,

the hollow perforation needle is sealably slidingly mounted in the connection base at a proximal portion of said connection base;

the air circulation means include an orifice emerging on the outside,

the emerging orifice is closed by the filtration means;

the filtration means include a filter for particles in the vicinity of a value between about 2 μm and about 5 μm;

the connection base includes, at a distal portion, a clipping stopper designed to allow mounting by clipping of the interface device on the perforable bottle;

the clipping stopper is mounted on the connection base according to a ball coupling;

the needle includes, at a distal end, means for retaining the needle in the tubule;

the retaining means includes a deformation produced by crushing;

the interface device includes a second connection base on the syringe;

the second connection base includes means for filtering a liquid designed to be suctioned by the syringe from the perforable bottle;

the second connection base includes, at a proximal portion, a membrane connector allowing the direct and secured connection of the syringe; and

the second connection base is sealably mounted, at a distal portion, on a proximal end of the hollow perforation needle.

Other features and advantages of the invention will appear in the following description of one preferred embodiment. In the appended drawings:

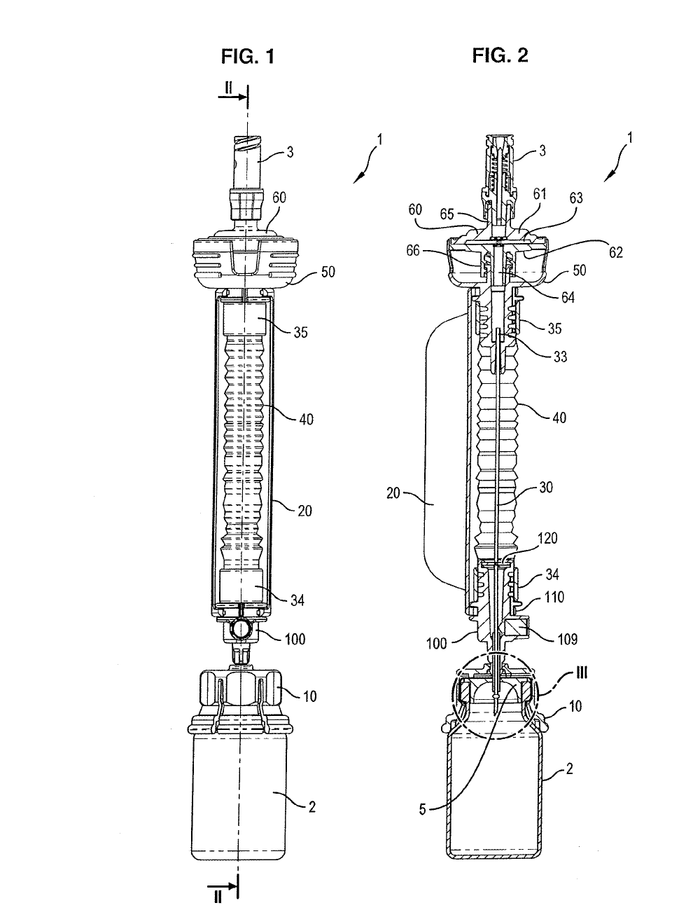

FIG. 1 is a side view of an interface device according to the invention mounted on a perforable bottle;

FIG. 2 is a cross-sectional view along II-II of the device of FIG. 1;

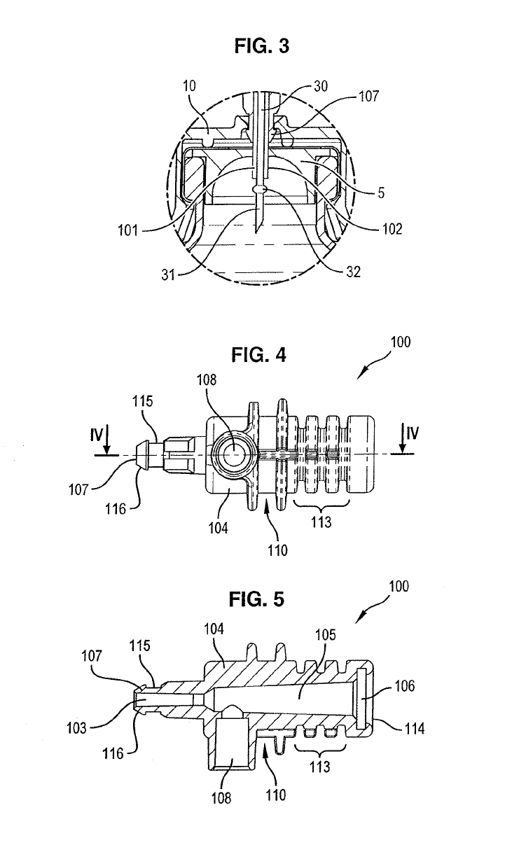

FIG. 3 is an enlarged detailed view of detail III of the interface device of FIG. 2;

FIG. 4 is a side view of the distal connection base of the interface device of FIG. 1;

FIG. 5 is a cross-sectional view along V-V of the connection base of FIG. 4;

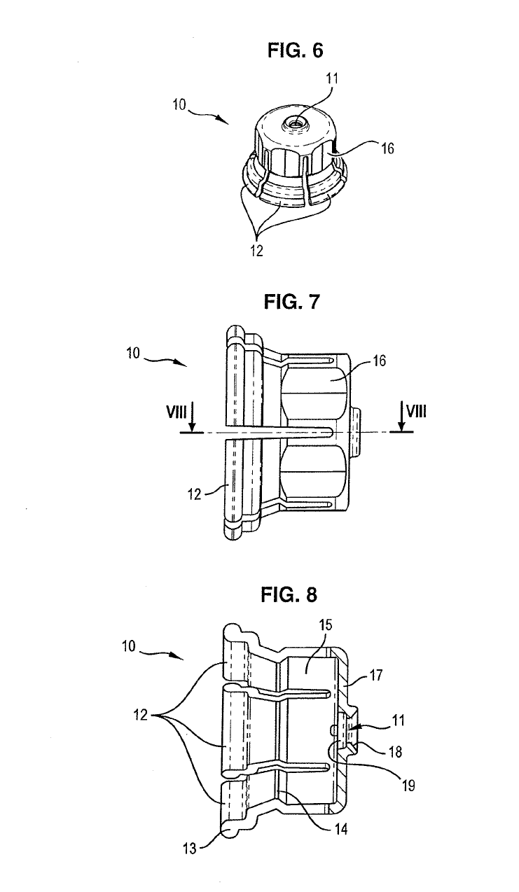

FIG. 6 is a three-dimensional view of the clipping stopper of the interface device of FIG. 1;

FIG. 7 is a side view of the clipping stopper of FIG. 6;

FIG. 8 is a cross-sectional view along VIII-VIII of the clipping stopper of FIG. 7;

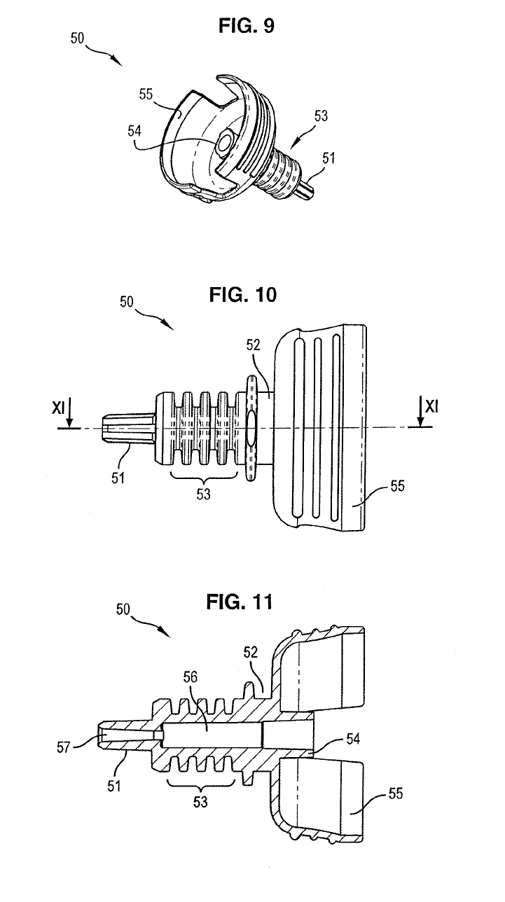

FIG. 9 is a three-dimensional view of the proximal connection base of the interface device of FIG. 1;

FIG. 10 is a side view of the connection base of FIG. 9;

FIG. 11 is a cross-sectional view along XI-XI of the connection base of FIG. 10;

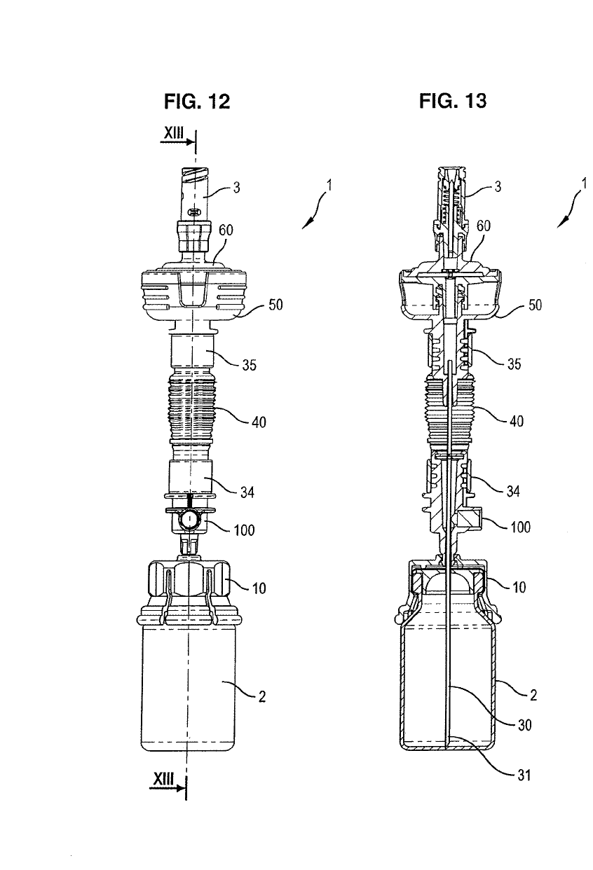

FIG. 12 is a side view of the interface device according to the invention of FIG. 1 mounted on the bottle in the low usage position;

FIG. 13 is a cross-sectional view along XIII-XIII of the interface device during a use as illustrated in FIG. 12;

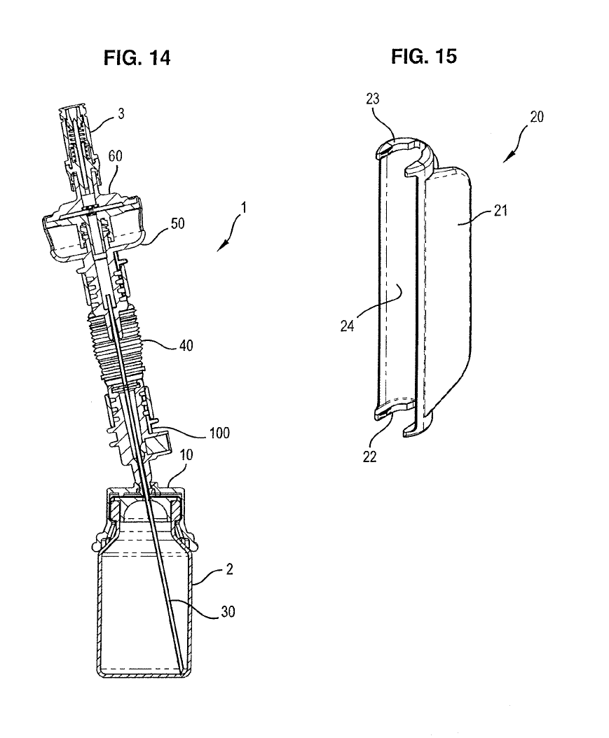

FIG. 14 is a cross-sectional view of the interface device of FIG. 12 inclined in relation to the bottle;

FIG. 15 is a three-dimensional view of the part allowing the storage and handling of the device according to the invention of FIG. 1 before placement on the perforable bottle.

In reference to FIGS. 1 and 2, we will describe the main elements of an interface device according to the invention. The interface device (1) is designed to be mounted on a perforable bottle (2), also called Vial, at a distal end of the interface device (1) and on a syringe (not shown) at a proximal end of said interface device (1). The interface device (1) includes, from the distal end toward the proximal end, a clipping stopper (10) designed to place and maintain said interface device on a perforable bottle (2), a first connection base (100), called “distal”, in which a hollow perforation needle (30) slides at the proximal end of which a second connection base (50), called “proximal,” is mounted, on which a filtration means (60) is installed. The filtration means (60) can be connected directly to a syringe containing a liquid to be infused designed to be mixed with a pure drug contained in the perforable bottle (2). Optionally, a membrane connector (3) is positioned between the syringe and the filtration means. Such a membrane connector (3) allows a direct and secured connection of said syringe on the interface device. Such a membrane connector is described in detail in document EP 0 544 581, to which one can refer for further information. The interface device (1) according to the invention also includes a deformable membrane (40) surrounding the hollow perforation needle (30) and fixed at a distal end on the distal connection base (100) and at a proximal end to the proximal connection base (50). Lastly, the interface device (1) according to the invention has a storage and handling device (20) that makes it possible to keep the two connection bases (100) and (50) apart from each other. Alternatively, the storage and handling device (20) comprises an extension that makes it possible to keep the clipping stopper (10) mounted in a predetermined position on the distal connection base (100).

In reference to FIGS. 2, 3, 4 and 5, we will now describe in detail the first connection base (100), called “distal”. The distal connection base (100) includes a body (104), here a single piece resulting from molding. The body (104) of the distal connection base (100) includes a tubular longitudinal chamber (105) extending between a proximal end (114) and a distal end (107) where the longitudinal chamber ends, in its extension, by a conduit (103). The longitudinal chamber (105) is, here, tapered in shape and rotary. The body (104) includes an orifice (108) essentially perpendicular to a main axis of the longitudinal chamber (105). The orifice (108) emerges on one hand in the longitudinal chamber (105) and on the other hand outside the body (104) forming the distal connection base (100). At the proximal end (114) of the distal connection base (100), the longitudinal chamber (105) has a circumferential groove (106) designed to receive a gasket (120) that is passed through slidingly by the hollow perforation needle (30) of the interface device (1). At the conduit (103), the distal connection base (100) includes a tubule (102) that is introduced in that conduit (103) and sealably fixed there, and so as to protrude slightly in the longitudinal chamber (105), on one hand, and, on the other hand, to extend beyond the distal end (107) of the distal connection base (100). The hollow perforation needle (30) is received essentially coaxially in the tubule (102) so as to slide with functional play (101) along a main axis of the tubule (102).

The orifice (108) emerging in the longitudinal chamber (105) is closed by filtration means (109). The filtration means (109) include, here, a particle filter making it possible to retain any particles in suspension in the air when the air passes through, regardless of the direction, the filtration means (109). For example, the particle filter has a porosity of about 0.2 μm, i.e. the filter retains all particles with dimensions greater than 0.2 μm.

The body (104) of the distal connection base (100) includes, on an outer circumference, a groove (110) adjacent to the orifice (108) and situated above said orifice in the proximal direction. This groove (110) is designed to cooperate with the storage and handling device (20) that will be described later.

Situated between this groove (110) and the proximal end (114) of the body (104), the distal connection base (100) has a series of ripples (113) on an outer perimeter of said body (104). As illustrated in FIG. 2, this series of ripples (113) is designed to receive one end of the deformable membrane (40) of the interface device (1) according to the invention. In order to keep this end of the deformable membrane (40) in place, a gripping jacket (34) surrounds the end of the membrane opposite the series of ripples (113) of the body (104) of the distal connection base (100).

At the distal end (107), the distal connection base (100) comprises a groove (115) topping, in the proximal direction, a rotary end (116) with a tapered shape. Said rotary tapered end (116) and said groove (115) are designed to receive and form a ball coupling with a clipping stopper (10) that will be described below.

In reference to FIGS. 6 to 8, we will now describe the clipping stopper (10). The latter part is generally essentially rotary cylindrical in shape. The clipping stopper (10) includes an essentially planar bottom (17) that is essentially perpendicular to an axis of revolution of the clipping stopper (10). The bottom (17) includes, in its center, a through opening (11) having a tapered inlet shape (18) then a counterbore (19). The through orifice (11) is designed to cooperate with the groove (115) and the tapered end (116) of the distal end (107) of the distal connection base (100), the counterbore (19) then being received in the groove (115). It should be noted that such a geometry of the through orifice (11) associated with the geometry of the distal end (107) of the distal connection base (100) allows an assembly with ball coupling of the clipping stopper (10) on the distal connection base (100) while preventing the clipping stopper (10) and the distal connection base (100) from separating during a placement of the interface device according to the invention on the perforable bottle (2). The clipping stopper (10) includes a series of tabs (12) uniformly distributed on a circumference and protruding, essentially parallel to the axis of revolution of the clipping stopper (10), from a radially outer periphery of the bottom (17) of said clipping stopper (10). Each of the tabs (12) includes a first portion (15) essentially parallel to the axis of revolution of the clipping stopper (10) followed by a ripple (14) oriented centripetally in relation to the axis of revolution of the clipping stopper (10), then a portion flaring in a tapered way (13). Each of the tabs (12) is also elastically deformable to allow the placement of the clipping stopper (10) on a neck of the perforable bottle (2). Once placed on the perforable bottle (2), the clipping stopper (10) remains held captive by the neck of the perforable bottle (2) at the portion (15) of the tabs (12), the ripples (14) keeping the neck in place whereas the end of the portions (13) comes into contact with an outer wall of the perforable bottle (2), as illustrated in FIGS. 1, 2, 12 to 14.

Now, in reference to FIGS. 9 to 11, we will describe the second connection base (50), called “proximal”. The proximal connection base (50) has a generally cylindrical rotary shape. Like the distal connection base (100), the proximal connection base (50) is, here, a single piece resulting from molding. The proximal connection base (50) includes a distal end (51) in which a conduit (57) is arranged emerging in a tubular chamber (56) having an essentially cylindrical rotary shape. A central portion of the proximal connection base (50) includes a series of ripples (53), the role of which is similar to the series of ripples (113) of the distal connection base (100) just described. The series of ripples (53) makes it possible to keep in place, in cooperation with a gripping jacket (35) similar to the gripping jacket (34) previously described, the other end of the deformable membrane (40) of the interface device (1) according to the invention. Adjacent to that series of ripples (53), the proximal connection base (50) has a groove (52) on an outer circumference of the proximal connection base (50). This groove (52) has the same function as the groove (110) of the connection base (100) and is therefore designed to cooperate with the storage and handling device (20) of the interface device (1) according to the invention. Lastly, at a proximal end, the connection base (50) includes, on one hand, a female connector (54) extending the chamber (56) and realized according to the Luer or Luer-Lock standard and, on the other hand, a shell made up of two petals (55) extending around the female connector (54). Each of the petals (55) is essentially semi-circular with main axis of the proximal connection base (50).

Given that the female connector (54) meets the Luer or Luer-Lock standards, it is capable of directly receiving a syringe having a male tip meeting the Luer or Luer-Lock standard, the petals (55) then receiving the base of the body of the syringe. In an alternative embodiment, illustrated here, in the different figures, the female connector (54) receives a filtration device (60) that we will now describe in reference to FIG. 2.

The filtration device (60) includes a downstream element (62) itself including a male connector (66) meeting the Luer or Luer-Lock standard and including a conduit (64). The filtration device (60) includes an upstream element (61) that has a female connector (65) meeting the Luer or Luer-Lock standard. The upstream (61) and downstream (62) elements are placed one on the other, head to tail, and thus define a chamber (63) capable of receiving a particle filter that will make it possible to retain the particles in suspension in the liquid to be infused that will pass through the filtration device (60). For example, the particle filter will not allow particles in suspension to pass into the liquid to be infused having dimensions greater than a value between about 2 μm and about 5 μm. The female Luer or Luer-Lock connector (65) is designed to directly receive the male Luer or Luer-Lock tip of the syringe or a membrane connector (3), as illustrated in FIG. 2, for instance.

The second connection base (50), called “proximal”, is mounted on a proximal end (33) of the hollow perforation needle (30) such that the hollow perforation needle (30) protrudes slightly in the chamber (56) of the proximal connection base (50). The mounting of the proximal connection base (50) on the needle (30) is done sealably at the conduit level (57).

Again in reference to FIG. 3, the hollow perforation needle (30) includes, at a distal end (31), a bevel topped with retaining means (32), the dimensions of which are slightly larger than an inner diameter of the tubule (102) in which the hollow perforation needle (30) is slidingly mounted. This makes it possible to prevent the needle from completely leaving the tubule. For example, the retaining means (32) include a slight deformation produced by crushing of the hollow perforation needle (30).

In reference to FIG. 15, we will describe the aforementioned storage and handling device (20). This device includes an essentially cylindrical rotary body (24), hollow and open on one side. The body (24) includes handling tabs (21) that protrude from a side opposite the opening, facing each other, and tangentially to the body (24). Each of the ends of the body (24) has a clip (23, 22) designed to cooperate with the groove (52) of the proximal connection base (50) and the groove (110) of the distal connection base (100), respectively. Alternatively, the storage and handling device (20) includes a protuberance protruding from the end including the clip (22) essentially parallel to an axis of revolution of the body (24). This protuberance is designed to come into contact with the clipping stopper (10) in order to neutralize the ball coupling existing between the clipping stopper (10) and the distal connection base (100).

Now, in reference to FIGS. 1, 2, 12 to 14, we will describe a use and an operation of the interface device (1) according to the invention just described.

In storage, the interface device (1) is equipped with a storage and handling device (20), as illustrated in FIGS. 1 and 2. The caregiver responsible for the preparation grasps the interface device (1) by the tabs (21) of the storage and handling device (20). He then clips the clipping stopper (10) on the neck of the perforable bottle containing the drug, which results, on one hand, in making the bottle integral with the interface device (1) according to the invention, and, on the other hand, in causing a perforation of the membrane (5) closing the neck of the perforable bottle by, first, the beveled distal end (31) of the hollow perforation needle (30), then the distal end of the tubule (102). Air then enters the perforable bottle. This incoming air passes through the filtration means (109) of the emerging opening (108), then through the longitudinal chamber (105) to finally flow into the functional play (101) between the tubule and the hollow perforation needle (30). Thus, if drug or pollution particles are pushed either outside the bottle by the air or inside said bottle, they are blocked on one hand by the gasket (120), and on the other hand by the filtration means (109). It should be noted that the air and the particles are capable of entering the bottle through the hollow perforation needle (30), but, on one hand, this circulation is blocked by the membrane connector (3) if the latter is present and, on the other hand, in any event, the particles are blocked by the particle filter placed in the chamber (63) of the filtration device (60).

Once the bottle (2) is perforated, the caregiver responsible for preparation connects a syringe filled with the liquid to be infused (physiological saline solution, for example) with the membrane connector (3), if the latter is present, or directly on the female Luer or Luer-Lock connector (65) of the filtration device (60). The liquid to be infused is then injected into the perforable bottle (2), which pushes the air contained in said bottle to the outside, air that can only exit through the filtration means (109) of the through orifice (108) of the distal connection base (100). If this air contains particles, they are then blocked by the gasket (120), on one hand, and, on the other hand, the filtration means (109). The caregiver responsible for the preparation then shakes the bottle in order to best dilute the drug contained in the bottle (2) with the liquid to be infused that was injected. The caregiver then removes the storage and handling device (20) by pushing the two tabs (21) toward each other to open the ends forming a clip (23) and (22) so that these can be removed from grooves (52) of the proximal connection base (50) and (110) of the distal connection base (100). Once the storage and handling device (20) is removed, the caregiver can then insert the hollow perforation needle to the bottom of the bottle by sliding said needle (30) in the connection base (100) for example by pushing on the connection base (50). Once the hollow perforation needle (30) has reached the bottom of the bottle, the caregiver can suction, with the syringe, the mixture thus created and re-inject it into the bottle several times to best homogenize it. During these manipulations, air goes in and out of the bottle (2), necessarily passing through the filtration means (109). Moreover, the liquid to be infused, when it is re-suctioned in the syringe, is filtered through the filtration device (60), preventing particles of pure drug that is not yet diluted from entering the syringe.

Once the mixture of the liquid to be infused and the drug is ready, the caregiver responsible for the preparation suctions it a last time into the syringe. To keep from leaving the preparation, which is often very expensive, in the perforable bottle (2), the caregiver can tilt the perforable bottle (2) and cause the interface device (1) according to the invention to swivel at the connection between the clipping stopper (10) and the distal end of the distal connection base (100) in order to reach, with the bevel (31) of the hollow perforation needle (30), the lower and inner edge of said perforable bottle (2) as illustrated in FIG. 14. Once all of the mixture is suctioned by the syringe, the empty perforable bottle (2)/interface device according to the invention (1) assembly is thrown away as is, without disconnecting the bottle from the interface device (1). The hollow perforation needle (30) cannot come out of the bottle due to the presence of retaining means (32) at the distal end (31) of the hollow perforation needle (30). Thus, the caregiver responsible for the preparation is protected from any accidental prick with this hollow perforation needle (30).

It should be noted that at no time was the needle touched, so there is no possible contamination of the caregiver by the mixture or of the mixture by the caregiver. Moreover, the membrane of the membrane connector (3) is easy to clean before any connection of the syringe.

Of course, it is possible to make a number of changes to the invention without going beyond the scope thereof.

1. An interface device, designed to connect a syringe to a perforable bottle containing a drug, comprising a hollow perforation needle and a base for connection to the perforable bottle, which connection base comprises air circulation means designed to allow air in and out of the perforable bottle, comprising air filtration means and a tubule designed to extend into the perforable bottle at a distal end of the tubule, wherein the hollow perforation needle is mounted slidingly with functional play in the tubule.

2. The interface device according to claim 1, wherein the hollow perforation needle is sealably slidingly mounted in the connection base at a proximal portion of said connection base.

3. The interface device according to claim 1, wherein the air circulation means include an orifice emerging on the outside.

4. The interface device according to claim 3, wherein the emerging orifice is closed by the filtration means.

5. The interface device according to claim 4, wherein the filtration means include a filter for particles in the vicinity of a value between about 2 μm and about 5 μm.

6. The interface device according to claim 1, wherein the connection base includes, at a distal portion, a clipping stopper designed to allow the mounting by clipping of the interface device on the perforable bottle.

7. The interface device according to claim 6, wherein the clipping stopper is mounted on the connection base according to a ball coupling.

8. The interface device according to claim 1, wherein the hollow perforation needle includes, at a distal end, means for retaining the needle in the tubule.

9. The interface device according to claim 8, wherein the retaining means include a deformation produced by crushing of the hollow perforation needle.

10. The interface device according to claim 1, further comprising a second connection base on the syringe.

11. The interface device according to claim 10, wherein the second connection base includes means for filtering a liquid to be suctioned by the syringe from the perforable bottle.

12. The interface device according to claim 10, wherein the second connection base includes, at a proximal portion, a membrane connector allowing the direct and secured connection of the syringe.

13. The interface device according to claim 1 wherein the second connection base is sealably mounted, at a distal portion, on a proximal end of the hollow perforation needle.
